(19) United States
(12) Patent Application Publication
(10) Pub. No.: US 2006/0158985 A1
(43) Pub. Date: Jul. 20, 2006

(54) DVD and a file copy method thereof

(75) Inventor: Sang-Cheol Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/292,123

(22) Filed: Dec. 2, 2005

(30) Foreign Application Priority Data
Jan. 20, 2005 (KR) 2005-5502

(51) Int. Cl. G11B 20/10; G11B 5/09

(52) U.S. Cl. 369/47.12; 369/84

(57) ABSTRACT

A Digital Versatile Disc (DVD) and a file copy method thereof are disclosed. Copy control information data disposed only with addresses of encoded data is read out and is inserted into contents. Whether to copy is selected when the contents are recorded, such that whether to copy or not is decided at an initial high speed copy stage. Thereby an adequate use of the copy prevention contents may is enabled.

### CROSS-REFERENCE TO RELATED-APPLICATION

This application claims benefit under 35 U.S.C. § 119(a) of a Korean Patent Application No. 2005-5502, filed in the Korean Intellectual Property Office on Jan. 20, 2005, the entire content of which is hereby incorporated by reference.

### BACKGROUND OF THE INVENTION

1. Field of the Invention

The present invention relates to a Digital Versatile Disc (DVD). More particularly, the present invention relates to a DVD and a file copy method thereof adapted for easy use in high speed copy.

2. Description of the Related Art

Image recording/reproducing devices, which are capable of recording broadcast signals on a recording medium and reproducing the recorded signals, have been provided with a plurality of functions according to technologies of broadcasting digitized and compressed signals developed. Recently, the image recording/reproducing devices are being provided with a hard disc driver configured as a large-scale memory. Developments have been also made to support the use of various image sources comprising satellite and cable broadcasting signals, network broadcasting via Internet, such that optical media, such as Compact Disc Read Only Memory (CD-ROM) titles or DVD titles, are constructed to store data or reproduce the stored data.

Because the optical media, such as DVD titles storing audio data and video data, can store data up to hundreds Mbytes through several Gbytes, image recording/reproducing devices having simple recording/reproducing functions adopt a large scale memory device of hard disc driver for storing and reading a large amount of data.

FIG. 1 is a schematic diagram illustrating a conventional Digital Versatile Disc/Hard Disc Drive (DVD/HDD) image recording/reproducing device. Referring to FIG. 1, a conventional Digital Versatile Disc (DVD)/Hard Disc Drive (HDD) image recording/reproducing device will be explained in detail. The DVD/HDD image recording/reproducing device comprises a switching unit 10, a Moving Picture Experts Group (MPEG) encoder unit 20, a HDD 30, a Flash ROM 40, a controller 50, a Random Access Memory (RAM) 60, a Nonvolatile RAM (NVRAM) 62, a light receiving unit 70, a digital signal processor 80, and an optical media player 90.

The switching unit 10 receives a variety of image data/audio data sources from outside, or outputs image data sources output from a decoder unit 80 to outside, for example, monitor screen and the like. The switching unit 10 receives external signals such as component and composite applied from broadcast signals and video (not shown) and selectively connects the external signals to a functional block within the image recording/reproducing device.

For example, if an external signal applied from external devices such as video and the like is a component or composite signal, the external signal is applied to a MPEG encoder unit 20.

The MPEG encoder unit 20 comprises a video decoder 21, an audio Analog-to-Digital Converter (ADC) 22 and a MPEG encoder 23. The MPEG encoder unit digitizes analog form data of image data sources applied from the switching unit 10 and compresses the digital form data to MPEG format, for example, MPEG-2 format. Conventionally, when the MPEG format of image data is stored in a storage medium such as the HDD 30, the image data takes a compressed form to reduce the size of the space. The HDD 30 is so constructed as to store or retrieve image data and audio data having the MPEG format at a data recording region in file format.

The ROM 40 is a program memory where programs of a controller are stored. The controller 50 controls a system where DVD titles reproduced by a DVD player is copied by the HDD 30 or copied by a Twin Tray DVD (not shown), and applies to the digital signal processor 80 so as to retrieve image data/audio data stored in the HDD 30. When DVD is reproduced, the controller 50 reads information relative to DVD titles at a disc information file region to record the information at a route directory region of the HDD 30.

The RAM 60 loads a file when the controller 50 edits the file stored in the HDD 30. In other words, the file stored in the HDD 30 is not directly edited, but the file is edited by the RAM 60 and is restored by the HDD 30.

The NVRAM 62 is a nonvolatile memory and may comprise a Static RAM (SRAM) or Flash ROM. The NVRAM 62 represents a memory that can maintain data even power is turned off and can store necessary restored information that is necessary after the power-off. In other words, when video data is recorded, the NVRAM 62 can store information, such as video record format and a file system controlling thereof, relative to the recorded video, and when power is turned off, the NVRAM 62 compares recorded information stored in the disc with the file system to determine that the power has been forcibly cut off by black-out or the like during recordation and to restore the information.

The light receiving unit 70 receives a control signal (not shown) generated by a setup key (not shown) mounted at a remote controller (not shown) or a video recording/reproducing device for controlling, for example, channel switching, volume adjusting, screen quality adjusting and the like, the video recording/reproducing device and inputs the signal to the controller 50.

The digital signal processor 80 receives via the controller 50 the video data of the MPEG format stored in the HDD 30 and decode the video data and converts the data to a video format, for example, National Television System Committee/Phase Alternating Line (NTSC/PAL). The converted signal is reproducible by a video display device such as a TV set and the like.

The DVD player 90 reads video data and audio data from the DVD disc and stores the data in the HDD 30 or applies the data to the digital signal processor 80 for reproduction or records the signal applied from the MPEG encoder 20.

Conventionally, a DVD title contains a Video objects (VOB) which is a video file, an IFO (DVD information) which is information file related to the video file and a IFO Back-up (BUP) which is an IFO file back-up, and a DVD title has one or several VOB files. The VOB comprises one or more Video Object Units (VOBU), and each VOBU composes video data, audio data, sub picture data and real-time date information.

In the construction thus described, when the DVD title is copied in hard disc or Twin Tray DVD, it is structured such that VOB and IFO files are extracted from the DVD and copied into hard disc or DVD. At this time, a copy preventive code stored in the DVD original file is decoded and directly copied by the hard disc or DVD. This type of copying method can selectively copy the VOB files in the DVD, or copy the entire DVD files in hard disc.

In order to prevent an unauthorized copying, the DVD title uses a total of seven copy preventive systems comprising analog Copy Protection system (CPS), Content Scrambling System (CSS), Digital Copy Protection System (CPS), Copy Generation Management System (CGMS), Content Protection for Prerecorded Media (CPPM), Content Protection for Recordable Media (CPRM), and among these systems, Analog CPS called Macrovision and CSS are the most commonly used.

The Analog CPS (Macrovision) which is a preventive device that prevents DVD from being copied in VHS is so constructed as to allow copied tapes to be output with noises or only with black and white images.

The CSS is a preventive device used for preventing copying of DVD titles in a Personal Computer (PC). Data recorded in the DVD title is not sequentially recorded but scrambled. The DVD player and software decode according to a key having a special value contained in the title, interpret and reproduce scrambled images in order. The DVD is disposed with a CSS code necessary for reproduction and the DVD player has a function of checking the code. The DVD title may be copied by PC but cannot be reproduced because of there being no way of copying the code.

Each disc has information designating whether to allow the content of the code to be copied, and this information is what is called a serial copy generation management system (CGMS) for preventing copying or copying a copy file. The CGMS information is contained in a sent video signal and transmitted, and in order for the CGMS to operate, a copying mechanism should reflect the CGMS and recognize it. An Analog standard CGMS (CGMS/A) encodes the data in the 21^{st} line of NTSC, and although it is not decided yet, a Digital standard CGMS (CGMS/D) is applied to a digital connection such as IEEE 1394/FireWire, the entire content of which is hereby incorporated by reference.

The CPPM replaces the CSS in the DVD-Audio area, a key value thereof is stored in a lead-in area, and a key value of disc is replaced by album identifier.

The CPRM is a mechanism tying the recording and medium recorded therein, and each blank recordable DVD has an intrinsic disc ID of 64-bit inscribed in BCA. When a lawfully protected content is recorded in a disc, 56-bit C 2 code extracted from disc ID is used for encoding, and during reproduction, the disc ID is read out from the BCA and used for generating a key for decoding a content code of the disc. If the content of the disc is copied by other media, and if the ID is not identical, or missing, the content code of the disc is not raveled out.

The DCPS does not allow a perfect digital copying and allows an exchange of keys via a protocol among interconnected relevant devices, and prevents an unauthorized device from copying contents, such that devices having no decryption function can reproduce only movies that are not encoded.

What should be paid attention to during DVD title copying thus mentioned is whether there is any copy prevention of the contents, and when dubbing is implemented in re-encoding format, presence and absence of copy prevention of audio/video pack during RDI Packing decoding is noticeable in real time to enable to enforce an encoding-preventive measure. However, in case of file copy which is a high speed copying, there is no knowing of a copy preventive pack being included in a certain section before the high speed copying is implemented.

In other words, in DVD combination or DVD Twin Tray model, if it is assumed that no bit rate change exists during VR or VR dubbing, file copying is implemented relative to a part corresponding to relevant VOB of VRO file which is a MPEG stream file and copy of IFO file corresponding to relevant title in file copy format. In case of dubbing relative to copy preventive title, because information relative to presence and absence of copy prevention of RDI pack of each VOBU is contained, there is no problem in coping with the copy prevention by way of stopping/pausing the encoding at a relevant part. However, there is no knowing of information relative to copy prevention relative to a certain RDI pack before dubbing in case of file copy, such that differentiation should be made relative to whether to copy or not, only with information of a first Realtime Data Information (RDI)-Pack information in case of relevant title. However, in case of some titles, and in case of copy prevention being contrived in a certain VOBU in VOB, there is a problem in that copy prevention cannot be separately implemented only on the relevant part.

### SUMMARY OF THE INVENTION

An object of the present invention is to address the afore-mentioned problem and another object of the present invention is to provide a Digital Versatile Disc (DVD) and a file copy method of being configured to record information in advance during encoding of copy prevention title for use in file copy.

In accordance with an object of the present invention, a recording medium is provided. The medium may copy contents attached with a code for distinguishing whether to encode or not at each data and records in such a manner that a copy control information data disposed only with addresses of encoded data can be inserted into the contents. Whether to copy the contents is selected when copy control information data disposed only with addresses of encoded data is read out and is inserted into the contents.

In accordance with another object of the present invention, a method of recording contents into a recording medium for copying contents attached with a code for distinguishing whether to encode is provided. The method comprises the steps of collecting only addresses of encoded data to generate copy control information data, and inserting the generated copy control information data into the contents and recording same.

In accordance with still another object of the present invention, a method of recording contents into a recording medium for copying contents attached with a code for distinguishing whether to encode is provided. The method comprises the steps of recording copy control information data collected with only the addresses of encoded data, and selecting whether to copy the contents when the copy control information data is inserted into the encoded data.

Preferably, the copy control information data is recorded in a first a Realtime Data Information (RDI)-pack of Video Object Unit.

Preferably, the copy control information data comprises an encoded Video Object Unit (VOBU) pair number, a first Video Object Unit start number and a first Video Object Unit finish number.

Preferably, the copy control information data is recorded in manufacturer's information of the RDI-pack.

### BRIEF DESCRIPTION OF THE DRAWINGS

The above aspects and features of the present invention will be more apparent by describing exemplary embodiments of the present invention with reference to the accompanying drawings, in which:

FIG. 1 is a schematic diagram illustrating a conventional Digital Versatile Disc/Hard Disc Drive (DVD/HDD) image recording/reproducing device;

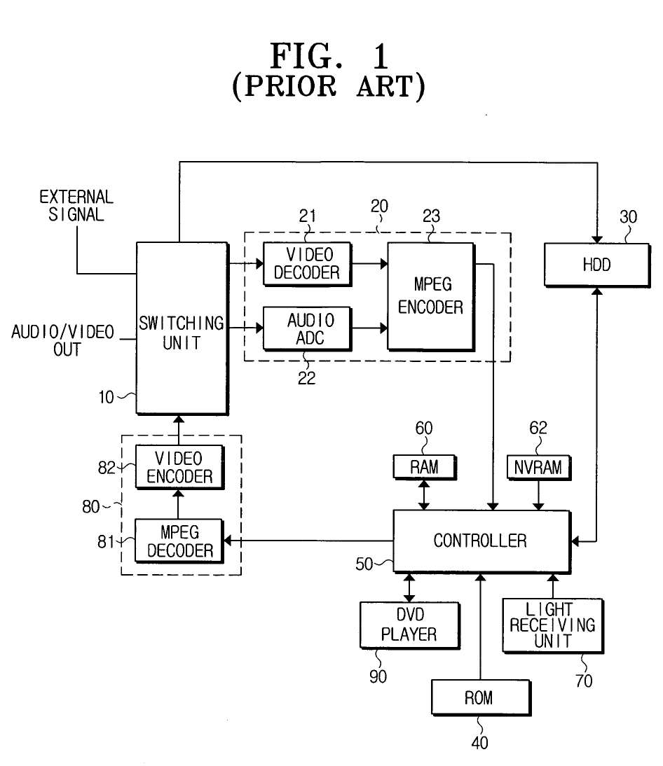

FIG. 2 is a flow chart illustrating an encoding process according to an exemplary embodiment of the present invention;

FIG. 3 is a flow chart illustrating a dubbing process according to an exemplary embodiment of the present invention; and

FIG. 4 is a block diagram illustrating a data construction of a first Video Object Unit (VOBU) according to an exemplary embodiment of the present invention.

Throughout the drawings, like reference numerals will be understood to refer to like parts, components and structures.

### DETAILED DESCRIPTION OF EXEMPLARY EMBODIMENTS

Exemplary embodiments of the present invention will be described in greater detail with reference to the accompanying drawings.

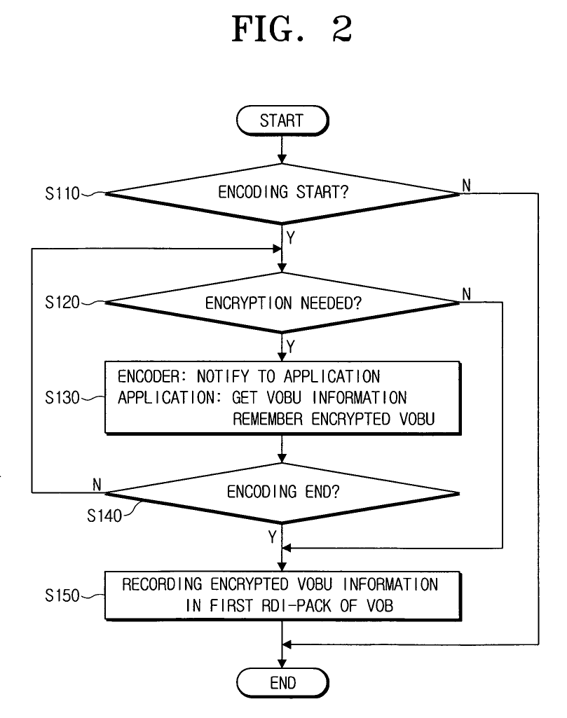

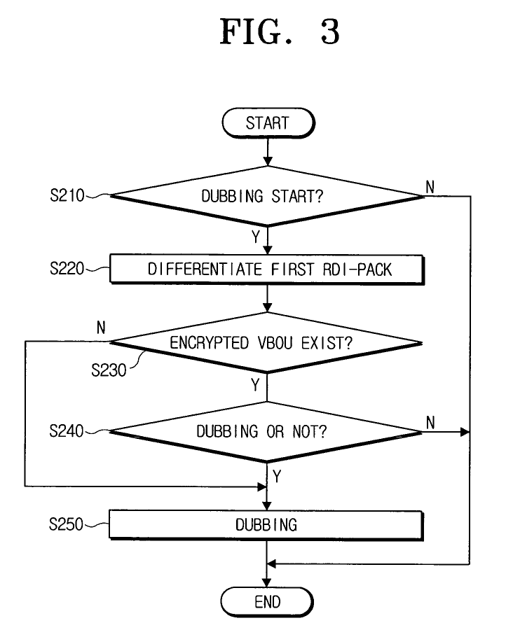

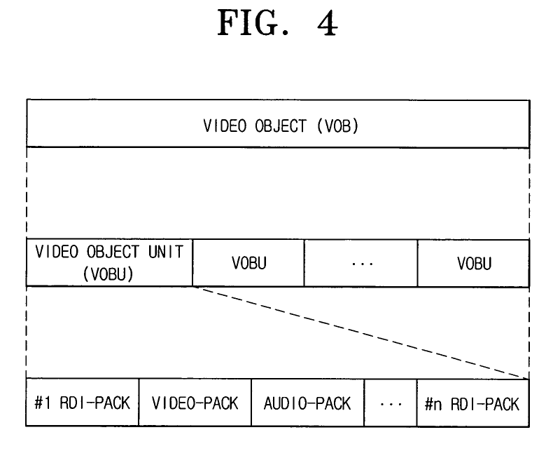

FIG. 2 is a flow chart illustrating an encoding process according to an exemplary embodiment of the present invention, FIG. 3 is a flow chart illustrating a dubbing process according to an exemplary embodiment of the present invention, and FIG. 4 is a block diagram illustrating a data construction of a first Video Object Unit (VOBU) according to an exemplary embodiment of the present invention.

An encoder (23) differentiates whether a signal reproduced by a Digital Versatile Disc (DVD) player 90 is encoded in each VOBU during encoding and transmits the encoded VOBU information to a controller 50. The differentiation is made whether encoding has been implemented in relevant VOBU using Display Content Information—Copy Control Information (DCI-CCI) which is a differentiating data of whether an encoding has been implemented of a code in a Realtime Data Information (RDI)-pack of each VOBU.

The controller 50 stores the encoded VOBU information transmitted from the encoder 23, and records in a first RDI-pack (#1 RDI-pack) of the VOB (Video Object) the VOBU information in an encoded title session section and uses the VOBU information as copy control information data when the encoding is finished.

Referring to FIG. 4, the VOB comprises a movie VOB and a still picture VOB, and each VOB comprises one or more VOBUs. The VOBU is generally indicated in one title, and records a title session section encoded in the first VOBU of the VOB.

The record is recorded in a Manufacturer's Information (MNFI) which is a reserved domain of RDI unit. The MNFI domain comprises 1979 bytes.

Preferably, a start number of the VOBU encoded at the domain and a finish number (hereinafter referred to as VOBU pair) are recorded but the VOBU pair comprises 2 bytes respectively, a total of 4 bytes, and comprises less than 16 sets to cope with the real time condition.

For example, the encoded VOBU pair comprises 1 byte, and a first VOBU start number comprises 2 bytes, and a first VOBU finish number comprises 2 bytes.

Now, the encoding process will be described in greater detail with reference to FIG. 2.

The controller 50 differentiates whether an encoding is needed at step S110. If it is differentiated at S110 that encoding is needed, the encoder 23 differentiates whether an encryption is needed at step S120. If it is differentiated that the encryption is needed, the encoder 23 transmits the information to the controller 50 and at the same time transmits encrypted VOBU information to the controller 50. The controller 50 stores the encrypted VOBU information in a buffer at step S130.

The process is repeated until the encoding is finished, and when the encoding is finished at step S140, the controller (50) records the encoded VOBU information which is a copy control information data at a first RDI-pack, such as an encoded title session section, at step S150. The recording method is such that the VOBU pair number encoded at the RDI Unit of MNFI domain comprises 1 byte, the first VOBU start number comprises 2 bytes, and the first VOBU finish number comprises 2 bytes. The recording method is the same as mentioned above, so that explanation thereto will be omitted for clarity and conciseness.

As mentioned earlier, as the VOBU information encoded by the changed function of the encoder 23 and the controller 50 is recorded in the first RDI-pack of VOB, each VOBU encoded information can be read out beforehand during dubbing to thereby enable to implement whether to select dubbing or not.

Now, referring to FIG. 3, the dubbing process will be described.

When dubbing is started to conduct a high speed title copy at step S210, the controller 50 reads out the copy control information recorded in the RDI-pack of the relevant title (VOB) at step S220.

If the data recorded in the first RDI-pack of VOB is not “0”, it can be differentiated that VOB contains the encrypted contents.

As a result of differentiation at step S220, if it is differentiated that encoded VOBU exists at step S230, the controller 50 displays a menu screen to allow a user to select whether to conduct the dubbing at step S240.

If selection is made to implement the dubbing even though a encoded VOBU exists at step S240, the controller 50 controls the system to allow implementing the dubbing at step S250, and when selection is made to stop the dubbing, the dubbing is stopped and finishes the operation

Although the above explanation has been made for a user to differentiate whether to dub or not when the encrypted VOBU is contained, preferably, the dubbing should not be performed.

Furthermore, if it is differentiated at step S230 that the encrypted VOBU exists, the controller 50 can obtain the encrypted VOBU pair number from the information recorded in the first RDI-pack of VOB.

It should be apparent that, in consideration of the above explanation, specification can be so arranged as to make a decision between whether to avoid the dubbing itself of the entire VOBU and whether not to dub the encrypted VOBU only.

As evident from the foregoing, there is an advantage in the DVD and the file copy method thereof thus described according to an exemplary embodiment of the present invention in that a decision can be made at an initial high speed copy stage as to whether a copy preventive action is taken against a title where copy prevention is partially recorded and as to whether the copy preventive action is taken against a title where only the copy prevention part is separately copy-blocked, such that copy prevention contents can be properly utilized.

Although the exemplary embodiments of the present invention have been described, it will be understood by those skilled in the art that the present invention should not be limited to the described embodiments, but various changes and modifications can be made within the spirit and scope of the present invention as defined by the appended claims.

What is claimed is:

1. A recording medium configured to copy contents attached with a code for distinguishing whether to encode at each data, wherein the medium records in such a manner that a copy control information data disposed only with addresses of encoded data can be inserted into the contents.

2. The medium of claim 1, wherein the copy control information data is recorded at a first Realtime Data Information (RDI)-pack of Video Object Unit (VOBU) of program stream.

3. The medium of claim 2, wherein the copy control information data comprises an encoded VOBU pair number, a first VOBU start number and a first VOBU finish number.

4. The medium of claim 3, wherein the copy control information data is recorded in information of the RDI-pack of a manufacturer.

5. The medium of claim 1, wherein the recording medium comprises a Digital Versatile Disc (DVD).

6. A recording medium configured to copy contents attached with a code for distinguishing whether to encode at each data, wherein whether to copy the contents is selected when copy control information data disposed only with addresses of encoded data is read out and is inserted into the contents.

7. The medium of claim 6, wherein the copy control information data is recorded in a first Realtime Data Information (RDI)-pack of Video Object Unit (VOBU) of program stream.

8. The medium of claim 7, wherein the copy control information data comprises:
an encoded VOBU pair number;
a first VOBU start number; and
a first VOBU finish number.

9. The medium of claim 8, wherein the copy control information data is recorded in information of the RDI-pack of a manufacturer.

10. The medium of claim 6, wherein the recording medium comprises a Digital Versatile Disc (DVD).

11. A method of recording contents into a recording medium for copying contents attached with a code for distinguishing whether to encode at each data, the method comprising the steps of:
collecting only addresses of encoded data to generate copy control information data; and
inserting the generated copy control information data into the contents and recording the contents.

12. The method of claim 11, wherein the copy control information data is recorded in a first Realtime Data Information (RDI)-pack of Video Object Unit (VOBU) of transport stream.

13. The method of claim 12, wherein the copy control information data comprises:
an encoded VOBU pair number;
a first VOBU start number; and
a first VOBU finish number.

14. The method of claim 13, wherein the copy control information data is recorded in information of the Realtime Data Information (RDI)-pack of a manufacturer.

15. The method of claim 11, wherein the recording medium comprises a Digital Versatile Disc (DVD).

16. A method of recording contents into a recording medium for copying contents attached with a code for distinguishing whether to encode at each code, the method comprising the steps of:
recording copy control information data collected with only the addresses of encoded data; and
selecting whether to copy the contents when the copy control information data is inserted into the encoded data.

17. The method of claim 16, wherein the copy control information data is recorded in a first Realtime Data Information (RDI)-pack of Video Object Unit (VOBU) of transport stream.

18. The method of claim 17, wherein the copy control information data comprises:
an encoded VOBU pair number;
a first VOBU start number; and
a first VOBU finish number.

19. The method of claim 18, wherein the copy control information data is recorded in information of the RDI-pack of a manufacturer.

20. The method of claim 16, wherein the recording medium comprises a Digital Versatile Disc (DVD).
